(19) United States
(12) Patent Application Publication
(10) Pub. No.: US 2025/0291468 A1
(43) Pub. Date: Sep. 18, 2025

(54) IMAGE PROCESSING METHOD, ELECTRONIC DEVICE, AND STORAGE MEDIUM

(71) Applicant: Lemon Inc., Grand Cayman (KY)

(72) Inventors: Yunzhu LI, Los Angeles, CA (US); Yitong LI, Beijing (CN); Jing Jie CHEN, Los Angeles, CA (US); Tang TANG, Beijing (CN); Yang LI, Beijing (CN)

(21) Appl. No.: 18/859,931

(22) PCT Filed: Mar. 10, 2023
(86) PCT No.: PCT/SG2023/050151

§ 371 Date: Oct. 24, 2024

(30) Foreign Application Priority Data
Apr. 24, 2022 (CN) 202210449213.7

(51) Int. Cl. G06F 3/04845; G06F 3/0488; G06T 19/00

(52) U.S. Cl. CPC G06F 3/04845; G06F 3/0488; G06T 19/00; G06T 2200/24

(57) ABSTRACT

An image processing method, an electronic device, and a storage medium are provided. The method includes: determining a target torso model corresponding to a target object in a case where it is detected that a special effect mounting condition is satisfied; determining a target special effect and target vertex information on the target torso model; determining a target mounting point corresponding to the target vertex information, and determining a current offset angle of the target object; and mounting the target special effect on the target object based on the target mounting point and the current offset angle, to obtain a special effect video frame.

This application claims the priority of a Chinese patent application filed to the China National Intellectual Property Administration on Apr. 24, 2022, with application Ser. No. 202210449213.7, the entire content of which is incorporated herein by reference.

### TECHNICAL FIELD

Embodiments of the present disclosure relate to the technical field of image processing, for example, to an image processing method, apparatus, electronic device and storage medium.

### BACKGROUND

With the development of network technology, more and more application programs enter the lives of users, especially a series of software that can shoot short video, which is deeply enjoyed by users.

In order to increase the interest of video capture, software developers may develop a variety of special effect props. However, the special effect props available to users are very limited, the richness of the video content is to be further improved, and at the same time, the special effect added to the video by users cannot interact with the video content. For example, when an image contains the user's body, the added special effect cannot interact with the user's body, and the effect of the special effect video generated based on the related special effect props is poor.

### SUMMARY

The present disclosure provides an image processing method, apparatus, electronic device, and storage medium that enable an added special effect to be associated with the user's limbs in a video image, and the orientation of the special effect corresponds to the orientation of the user's limbs in the image, thereby making the visual effect presented by the special effect video more realistic.

Embodiments of the present disclosure provide an image processing method, which includes: determining a target torso model corresponding to a target object in a case where it is detected that a special effect mounting condition is satisfied; determining a target special effect and target vertex information on the target torso model; determining a target mounting point corresponding to the target vertex information, and determining a current offset angle of the target object; and mounting the target special effect on the target object based on the target mounting point and the current offset angle, to obtain a special effect video frame.

Embodiments of the present disclosure further provides an image processing apparatus, which includes: a target torso model determination module, configured to determine a target torso model corresponding to a target object in a case where it is detected that a special effect mounting condition is satisfied; a target vertex information determination module, configured to determining a target special effect and target vertex information on the target torso model; a target mounting point determination module, configured to determine a target mounting point corresponding to the target vertex information, and determining a current offset angle of the target object; and a special effect video frame generation module, configured to mount the target special effect on the target object based on the target mounting point and the current offset angle, to obtain a special effect video frame.

Embodiments of the present disclosure further provide an electronic device, the electronic device includes: at least one processor; and a storage apparatus, configured to store at least one program, the at least one program, when executed by the at least one processor, causes the at least one processor to implement the image processing method according to any one of the embodiments of the present disclosure.

Embodiments of the present disclosure further provide a storage medium including computer-executable instructions, the computer-executable instructions, when executed by a computer processor, are used for performing the image processing method according to any one of the embodiments of the present disclosure.

### BRIEF DESCRIPTION OF DRAWINGS

FIG. 1 is a flowchart of an image processing method provided by embodiments of the present disclosure;

FIG. 2 is a structural diagram of an image processing apparatus provided by embodiments of the present disclosure; and

FIG. 3 is a structural diagram of an electronic device provided by embodiments of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units. Modifications of “one” and “more” mentioned in the present disclosure are schematic rather than restrictive, and those skilled in the art should understand that unless otherwise explicitly stated in the context, it should be understood as “one or more”.

The names of messages or information interacted between devices in the implementations of the present disclosure are for illustrative purposes only and are not intended to limit the scope of these messages or information.

Before illustrating the embodiments of the present disclosure, the application scenarios of the embodiments of the present disclosure may be exemplarily explained. For example, when a user uploads a recorded multimedia data stream to a service terminal corresponding to an application, or a video image is captured in real time by a mobile terminal including an imaging device, the application can detect the image contents of the captured video frames (i.e., a plurality of objects in the image) and determine a target object, the target object in the video image may be either dynamic or static, and the number of the target object may be one or more. Based on this, when the application detects the presence of the target object in the video image, a special effect selected by the user from a special effect pack and developed and designed in advance is mounted on a corresponding position of the torso of the target object, so as to obtain a plurality of special effect video frames, thereby allowing an interaction between the special effect and the image content, and a more interesting special effect video is generated based on the plurality of special effect video frames.

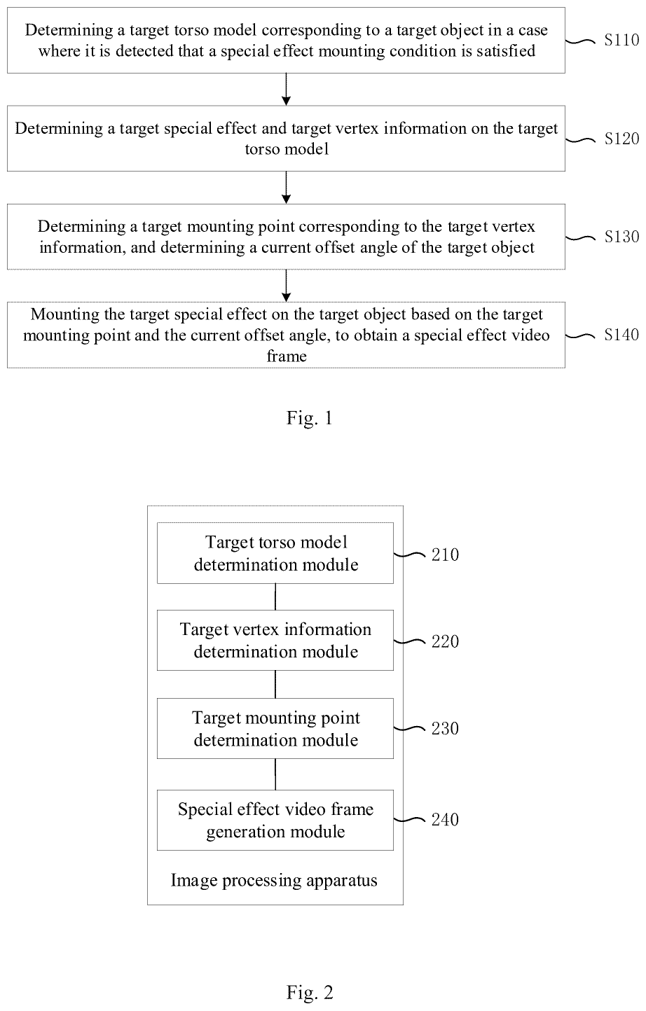

FIG. 1 is a flowchart of an image processing method provided by embodiments of the present disclosure. The embodiments of the present disclosure are applicable to the case where a current video frame is processed based on an application software to generate a special effect video. For example, in the case where a body of a target object is in a current video image, if a user selects a special effect from the special effect package and touches the body of the target object, the application can process a plurality of video frames according to the solution of the embodiments of the present disclosure, so that the special effect selected by the user is mounted on the body of the target object and a corresponding special effect video is obtained. The method may be performed by an image processing apparatus, which may be implemented in software and/or hardware, and optionally, by an electronic device. The electronic device may be a mobile terminal, a personal computer (PC) terminal, a server, or the like.

As shown in FIG. 1, the method includes the following steps.

S110, determining a target torso model corresponding to a target object in a case where it is detected that a special effect mounting condition is satisfied.

The apparatus for performing the image processing method provided by the embodiments of the present disclosure may be integrated in an application software supporting an image processing function, and the software may be installed in an electronic device, optionally, the electronic device may be a mobile terminal or a PC terminal, or the like. The application software may be a kind of software for image/video processing, and its application software will not be described in detail here, as long as the image/video processing can be implemented. It may also be a specially developed application in the software for adding and presenting the special effect, or integrated in a corresponding page, and the user can implement the processing of the special effect video through the integrated page in the PC terminal.

It should be noted that the implementations provided by the present embodiments may be performed on the basis of existing video files or during the process of the user photographing the video. For example, when the user pre-records a video containing a target object and uses the video as an original video, the user can actively upload the video to the service terminal corresponding to the application, select the target special effect from the special effect package provided by the application according to his/her own wishes, so that the service terminal constructs a 3-dimensional (3D) torso model for the target object in the video, and then processes a plurality of video frames in the video according to the implementations provided by the present embodiments. That is, the target special effect selected by the user is mounted on the torso of the target object in the video image, to obtain a special effect video frame; alternatively, the user can acquire video for the target object in real time using the mobile terminal equipped with a camera, the application may construct a corresponding 3D torso model for the target object when the application detects the target object in the video image acquired in real time, and when the application detects the user's touch control operation for the torso of the target object, the application can also process the plurality of video frames based on its own image processing function according to the implementations of the embodiments of the present disclosure, thereby obtaining the corresponding special effect video frame.

In this embodiment, the special effect mounting condition includes at least one of the following items: triggering a special effect mounting control; detecting that the target object is triggered; detecting that voice information triggers a special effect mounting wake-up word; and detecting that limb moving information is consistent with preset moving information, and it is understood that the special effect mounting condition is a trigger condition for mounting and displaying the special effect selected by the user on the torso of the target subject.

For the first special effect mounting condition described above, a control may be previously developed in the application software, and programs related to special effect mounting are associated with the control, based on this, when detecting that a user triggers the control, the application software invokes the related programs, determines the special effect selected by the user, and mounts the special effect on the torso of the target subject. It is understood that there are various ways in which the user triggers the control. Exemplary, when the client is installed on a PC terminal, the user may trigger the special effect mounting control by mouse click, and when the client is installed on a mobile terminal, the user may trigger the special effect mounting control by finger touch. It should be understood by those skilled in the art that the special effect mounting touch control method may be selected according to the actual circumstances, and the embodiments of the present disclosure are not limited thereto.

For the second special effect mounting condition, when the application receives an image or a video actively uploaded by the user or captured in real time by the camera, the image or video frames may be processed based on a pre-trained image recognition model to determine whether the image includes the target object. When the target object is shown in the image, the application needs to detect the triggering operation of the user in real time. If it is detected that the user triggers the target object, the application can mount the special effect selected by the user on the torso of the target object. For example, when the application detects the pattern of a cat as the target object in the currently shown image, if it is detected that the user clicks on the head region of the cat through the touch screen, the application can mount a special effect pre-selected by the user on the head of the cat.

For the third special effect mounting condition, the application software may be provided with specific information as the special effect mounting wake-up word, for example, one or more of words such as “mount”, “special effect mount” and “mount special effect” serve as the special effect mounting wake-up word. Based on this, when the application software receives the voice information from the user, the application software can recognize the voice information using a pre-trained voice recognition model, determine whether one or more of the predetermined special effect mounting wake-up words are included in the recognition result, and when the determination result is yes, the application can mount the special effect selected by the user on the torso of the target subject.

For the fourth special effect mounting condition described above, moving information of a plurality of people or animals may be input in the application software and used as preset moving information, for example, information reflecting the moving of a person lifting both hands as preset moving information, or information reflecting the moving of a cat standing up as preset moving information, based on this, when the application receives an image or a video that is actively uploaded by a user or captured in real time by an imaging device, the image or images in a plurality of video frames can be recognized based on a pre-trained limb moving information recognition algorithm, when the recognition result indicates that the limb moving information of the target object in the current image is consistent with the preset moving information, the application can mount the special effect selected by the user on the torso of the target object.

It should be noted that the above-described special effect mounting conditions may be simultaneously effected in the application software, or only one or more of the conditions may be selected to be effected in the application software, and the embodiments of the present disclosure are not limited thereto.

In this embodiment, the target object may be the user displayed in the display interface, for example, when a dance video of a user is played based on the application software for image processing, the dance user displayed in the video is the target object. Of course, in actual practice, the target object may also be a variety of living beings that are dynamic or static, for example, pets in the user's home, the embodiments of the present disclosure are not limited thereto.

There are two ways to determine the target object from the original video. In the first method, the user can pre-calibrate one or more target objects in the video frame, based on this, when application acquires the original video, the target object can be determined based on the calibration result of the user. In the second way, after the original video is uploaded to the service terminal, or in the process of capturing the video in real time, the application software can dynamically recognize the video image, and then determine one or more target objects based on the recognition result.

Accordingly, when the application detects the target object in the video image, a target torso model corresponding to the target object, which is generated in advance, or generated in real time, may be invoked. When the target object is determined in the first way (i.e., in the case where the object in the video picture is pre-calibrated), the application may create a corresponding target torso model for one or more target objects in real time after the original video is acquired, and when the target object is determined in the second way (i.e., in the case where the video image is dynamically recognized by the application to determine the target object), the application may construct a corresponding target torso model (3D mesh) for all the target objects in the video image, based on this, when the application recognizes the target object again during subsequent playback of the video, the constructed target torso model (3D mesh) corresponding to the target object can be directly invoked. It can be understood that the body of the target object is represented by the target torso model. For example, when the application detects the target object in a video image, the application may construct a 3D mesh reflecting multiple parts of the user's body in real-time using multiple patches, thereby taking the 3D mesh as the target torso model corresponding to the user, and after the target torso model is constructed, the application may also label the model and associate the model with the user as the target object, based on this, if the application detects the user's body image again in the video image in a subsequent process, the application can directly call the constructed 3D mesh as the target torso model. It should be understood by those skilled in the art that, when the application determines a corresponding target torso model for the target object, the user can also make editorial adjustments to the model according to actual needs, thereby further improving the accuracy of the subsequent mounting of the special effect on the body of the target object.

It should be noted that when the application constructs the corresponding target torso model for the target object, i.e., the target object appears multiple times in subsequent video images, the application does not need to reconstruct the model for the target object again, but rather directly calls the target torso model corresponding to the target object.

It should also be noted that, in actual practice, when the application software determines the target torso model, programs or algorithms are determined based on a pre-programmed key point, and one or more key points can be determined on the target torso model, for example, a transformation matrix may be determined based on the points where the key points on the target torso model correspond to a plurality of joints of the human body.

The transformation matrix is a matrix reflecting the association between a plurality of key points and a plurality of joint points of the human body. The transformation matrix may include a translation matrix and a rotation matrix, and the application determines how to translate or rotate the target torso model in the current video image and, in a subsequent process, determine the target display position of the plurality of pixels corresponding to the target torso model in the current video image. It can be understood that, based on the transformation matrix, a binding or association between the target torso model and the actual human body can be achieved, thereby ensuring that the target torso model can remain aligned with the moving human body in each moment, i.e., ensuring that the moving of the target torso model follows the actual moving of the human body in real time.

S120, determining a target special effect and target vertex information on the target torso model.

Optionally, first determining a touch point corresponding to the target object, determining the target vertex information on the target torso model corresponding to the touch point based on the touch point; or, determining a mounting portion corresponding to the voice information, and determining target vertex information of the target torso model corresponding to the mounting portion based on the mounting portion; or, determining the target vertex information according to a torso model corresponding to the limb moving information.

When the target vertex information is determined through the touch point, a to-be-processed torso model corresponding to the target object may be determined when it is detected that the target object is included in the display interface; determining vertex information of at least one patch, to obtain the target torso model corresponding to the target object, to determine the target vertex information corresponding to the touch point on the target torso model when the touch point is detected. It should be noted that the to-be-processed torso model is constituted by at least one patch; the vertex information is different for each patch. The patch refers to a mesh in an application software or application program that supports special effect image processing, which may be understood as an object in the application software for carrying an image; at the same time, each patch may be constituted by at least three vertices, on the basis of this, it can be understood that the vertex information of each patch is the position information of the plurality of vertices constituting the to-be-processed torso model.

In the actual determination process of the target torso model, a to-be-processed map corresponding to the to-be-processed body torso model may be determined, and then vertex information of the at least one patch may be determined based on the to-be-processed map. Since the target torso model includes a plurality of patches, the to-be-processed map may be one or more maps created by the application for the torso of the target subject, each map corresponds to a particular 3D mesh, it being understood that when the target subject is a user, each 3D mesh is at least used to characterize one region on the user's corresponding target torso model, e.g., to characterize the user's head region, it can be understood that, each 3D mesh characterizes at least one of the plurality of regions, and the plurality of 3D meshes characterize a plurality of different regions. Since each to-be-processed map includes a plurality of vertices, when the application determines a plurality of to-be-processed maps, the corresponding vertex arrangement information can be determined from the corresponding patch of the to-be-processed map, and the vertex information of the plurality of patches can be determined based on the vertex arrangement information. It is to be noted that, in the actual practice, after the created maps are associated with the 3D meshes, the vertices determined from the plurality of 3D meshes can also be set or the texture coordinates (UV) and conventional parameters of the vertices of the plurality of 3D meshes can be adjusted, thereby ensuring that the UV of the plurality of 3D meshes are not reused.

In this embodiment, when the target torso model is displayed on the display interface, the application software may also detect the touch operation of the user in real time. When the touch point is detected, the application may determine whether the touch point is located on the target object. If the touch point is determined to be located on the target object, the application can determine the target vertex information corresponding to the touch point on the target torso model. It can be understood that, since the target torso model is composed of at least one patch, and each patch is composed of at least three vertices, the target vertex information is the position information of the plurality of vertices constituting the target torso model, e.g., the coordinates of the plurality of vertices in a three-dimensional spatial coordinate system. Continuing with the above example, when a dancing user is shown in the video image, if other users touch on the display interface and the touch point is located on the body of the dancing user in the image, the application determines the coordinate information of the three vertices corresponding to the touch point, i.e., the target vertex information, on the user torso model of the dancing user.

In this embodiment, when the target vertex information is determined by the mounting portion corresponding to the voice information, it is also possible to preset specific information in the application software as the information for determining the mounting position in a manner of presetting the special effect mounting condition, for example, one or more words of “head”, “shoulder” or “leg” are used as the information for determining the special effect mounting position, and at the same time, the above information is also associated with the corresponding torso position. Based on this, when the application needs to mount a special effect on the body of the target object and receives voice information of the user, the voice information can be recognized using a pre-trained speech recognition model, and when it is determined that a word of “head” is included in the recognition result, the application determines a head region on the target torso model associated with the word, thereby determining target vertex information of this region.

In this embodiment, when the target vertex information is determined by the torso model corresponding to the limb moving information, the moving of the target object in the image may be detected in real time by the application, and when the target object is detected to make specific moving, a target region associated with the moving can be determined on the target torso model of the target object, and vertex information of this region can be determined as the target vertex information.

In the process of determining the target vertex information, it is also possible to determine a pixel of the touch point on the display interface, or to determine a pixel corresponding to the center of the mounting portion, or to determine a geometric center point of the torso model according to the torso model corresponding to the limb moving information, and use the geometric center point as the pixel, so as to determine the target patch corresponding to the pixel. According to the three vertex information of the target patch, target vertex information corresponding to the touch point is determined. When the video including the torso of the target object is in the playing state, if it is detected that the user clicks the body of the target object in the image through a mouse, the position clicked by the mouse of the user is the touch point; alternatively, when the video including the torso of the target object is displayed on the touch screen, if it is detected that the user triggers the body of the target object in the image by a finger or another device, the position where the finger or another device contacts the touch screen is the touch point.

In this embodiment, the application may also determine the center of the mounting portion as the pixel, for example, when the special effect mounting portion is determined to be an arm region of the user, the pixel of the center of the arm region may be directly determined, and when the special effect mounting portion is determined to be a head region, the pixel of the center of the head region may be directly determined; at the same time, since the target torso model may be either static or dynamic, a geometric center point may be determined on the torso model corresponding to the limb moving information. For example, when the target torso model is a user's limb model and one of the user's arms on the model is swinging, the application may determine the geometric center point of the user's arm portion on the model and use this point as the pixel.

Exemplarily, the application may first draw a corresponding render texture based on the plurality of video frames and output a UV value for each vertex thereof, it can be understood that a continuous and different UV value is set for each vertex of the mesh, based on this, when the user touches the body portion of the dance user in the display interface, the application may determine a script click event and parse to determine the position (i.e., pixel) of the user's click on the screen, and determine the UV of the corresponding triangle face (i.e., target patch) on the target torso model according to the pixel, and take the three vertex information characterizing the position of the triangle face as the target vertex information corresponding to the user's touch point.

Optionally, when determining the target vertex information based on the three vertex information of the target patch, performing interpolation processing on the three vertex information based on the three vertex information of the target patch and the touch point, and determining the target vertex information corresponding to the touch point. For example, when the application software determines a mesh of the target patch corresponding to area region on the torso of the target object, three vertex information corresponding to the patch may be determined, and in combination with the determined touch point, the three vertex information may be interpolated to determine the target vertex as a specific mounting point. It can be understood that image interpolation processing is a process of using gray values of known neighboring pixels (or tristimulus values in a rgb image) to generate gray values of unknown pixels, which is not be described in detail in the embodiments of the present disclosure.

S130, determining a target mounting point corresponding to the target vertex information, and determining a current offset angle of the target object.

In this embodiment, when the target vertex information is determined on the target torso model, in order to associate the target special effect selected by the user with the body of the user in the video image, the target mounting point corresponding to the target vertex information needs to be determined, and in order to make the orientation of the special effect consistent with the orientation of the torso of the user in the video image, the application needs to determine the current offset angle of the target object.

The target mounting point may be a point on the patch to which the target vertex is affiliated, and the target mounting point represents the mounting position of the target special effect. For example, when it is determined that the patch to which the target vertex is affiliated corresponds to the arm region of the user in the video image, the vertex corresponding to the patch may be determined as the target mounting point, or a point in the patch may be determined as the target mounting point.

In this embodiment, since the target object in the video image may be in a constant moving state, the orientation of the target object may be deflected by a certain angle respect to the virtual camera, and thus, the application needs to determine the current offset angle of the target object while determining the target mounting point. The current offset angle represents the orientation of the body of the user in the video image at the current moment. For example, the spine portion of the user in the video image is associated with the z-axis of the spatial coordinate system. When the target object is facing the virtual camera, a plane is determined from the target torso model of the target object and a normal line facing the virtual camera is obtained. Based on this, when the torso of the target object is deflected, a normal line is obtained again based on the target torso model. By calculating the angle between the two normal lines, the application determines the angle of deflection of the target torso model in the spatial coordinate system.

Optionally, the target mounting point on the display interface is determined based on the target vertex information, and the current offset angle of the target object is determined based on a deflection angle of the target torso model.

After the corresponding target vertex information (e.g., the position coordinates of the three vertices) of the target patch is determined, a plug-in component may be determined based on a pre-created interpolation value, and one of the vertices of the patch is determined as the target mounting point, or, a point in the patch is determined as the target mounting point. At the same time, a spatial coordinate system may be constructed in the virtual three-dimensional space based on the plug-in component, and any coordinate axis in the spatial coordinate system is selected to be associated with the target torso model of the target subject.

S140, mounting the target special effect on the target object based on the target mounting point and the current offset angle, to obtain a special effect video frame.

It should be noted that before mounting the special effect on the user's body in the video image, the user first needs to select the corresponding target special effect in the application software. The target special effect may be a special effect selected by the user from a special effect package provided by the application, for example, the target special effect may be an item, flower, jewelry, etc. that is displayed in the display interface and can be mounted on the body of the target subject.

In this embodiment, the target special effect further includes a static special effect and a dynamic special effect; the static special effect is a special effect fixed at the target mounting point and the dynamic special effect is a moving special effect associated with the target mounting point. For example, after previously generating a 3D balloon model as a static special effect using any image processing software and generating a control associated with the static special effect, if it is detected that a user clicks on the control, it may be determined that the user has currently selected the balloon special effect, and based on the user's touch point, the application may fix the 3D balloon model corresponding to the static special effect at a position on the user's body shown in the display interface; when a colored light band is previously generated as a dynamic special effect and a control associated with the dynamic special effect is generated, if it is detected that a user clicks on the control, it may be determined that the user has currently selected the light band special effect. Further, based on the user's touch point, the application may associate the light band corresponding to the dynamic special effect with a region on the user's body shown in the display interface, thereby causing the light band to move adaptively with the movement of the user's body in the interface to present a richer visual effect to the user.

In this embodiment, when the application determines the target mounting point and the current offset angle, the target special effect selected by the user may be mounted on the target object, for example, the 3D balloon model corresponding to the special effect selected by the user may be mounted on the body of the user who is dancing in the video image. It should be noted that, in a practical application, the mounting of the target effect on the target object can still be performed using the pre-created interpolation value determining the plug-in component, that is, using the plug-in component, a plurality of portions of the target object can be taken as an entity, so as to attach the special effect to the UV points of the target mesh of the entity, while the position of the mounted effect on the target torso model can also be adjusted by the lerp function.

In the actual application process, the target object may be classified into two classes, including a dynamic target object and a static target object, based on this, when the target object is static, after the application mounts a special effect selected by the user from the special effect package on the body of the target object, the special effect remains displayed statically; when the target object is dynamic, after the application mounts a special effect selected by the user from the special effect package on the body of the target object, and the special effect also moves adaptively with the moving of the target object, which is further described below.

When the mounted target special effect is a dynamic special effect, in order to obtain the corresponding special effect video frame, the display style, moving rate, and moving path of the dynamic special effect also need to be determined. The display style may be information that characterizes a dynamic special effect pattern, color, texture, etc., the moving rate may be a parameter that reflects how fast or slow the 2D map or 3D model corresponding to the target special effect moves in the display interface, and the moving path represents a trajectory that the 2D map or 3D model corresponding to the target special effect moves in the display interface. Of course, in practical applications, the display style, the moving rate, and the moving path of the dynamic special effect may be adjusted according to actual requirements, and the embodiments of the present disclosure are not limited thereto.

Optionally, the target mounting point is used as a starting point for the dynamic special effect, moving according to the moving path and a moving rate, to obtain a special effect video frame. The special effect video frame is a video frame obtained by adding a target special effect to an original video frame, and each special effect video frame carries the same time stamp as the original video frame, so that the special effect video corresponding to the original video is obtained by splicing multiple special effect video frames based on the time stamps. It can be understood that, in the special effect video, the 2D map or 3D model corresponding to the dynamic special effect will take the target mounting point as the starting point and move according to the moving path and moving rate determined by the application.

For example, when the target special effect selected by the user is a special effect corresponding to a particular object, the application may first determine a display style corresponding to the special effect, i.e., an object model associated with the special effect, and at the same time, determine that the moving rate of the object model in the display interface is 1, i.e., indicating that the model moves one unit length in the display interface per second, and determine that the moving path of the object model in the display interface is a horizontal line of a particular length, based on this, when the target mounting point is the left shoulder of the target object, indicating that the model is added to the video to obtain a special effect video frame, and after generating the special effect video based on the plurality of special effects video frames, the object model displayed in the special effect video moves from the left shoulder to the right shoulder of the target subject at a preset moving rate.

In the actual application process, the application may further determine at least one path vertex of the target specific effect on the target torso model based on the target vertex information of the target mounting point, the moving path, and the moving rate; and a special effect video frame of the target special effect moving on the target torso model is determined based on the target vertex information and the at least one path vertex. In the application of generating a special effect video based on the target special effect, since the target mounting point has been determined as the starting point of the 2D map or 3D model associated with the target special effect, and at the same time, the moving path and the moving rate of the model in the video have been determined, the application can calculate to obtain the plurality of path vertices of the target special effect on the target torso model through the pre-edited programs. For example, when the starting point of the moving of the 3D balloon in the video image, and the moving rate and the moving path of the 3D balloon are determined, the application can call and run the pre-edited path point determination programs to determine the plurality of path vertices. It can be understood that these vertices may directly reflect the moving path of the 2D map or 3D model associated with the target special effect.

Based on the target vertex information, which serves as the starting point for moving of the special effect, and the plurality of path vertices, the application can control the corresponding 2D map or 3D model of the target special effect to move in the image of the original video, to obtain a plurality of special effect video frames. It should be understood by those skilled in the art that, when the plurality of special effect video frames are obtained, the application may write information of a plurality of pixels in the special effect video frames into a rendering engine, thereby causing the rendering engine to render a image corresponding to the current special effect video frame in the display interface, the rendering engine may be a program that controls a graphics processing unit (GPU) to render a related image, i.e., may cause a computer to perform a rendering task of the plurality of special effect video frames, and the embodiments of the present disclosure are not described in detail herein.

It also needs to be explained that, in the actual application process, it is also possible to read the mesh corresponding to the user's body in the video image driven in real time by the algorithm through the pre-written script, and test whether the mounted 2D map or 3D model corresponding to the target specific effect can correctly follow the moving of the specific mesh, and at the same time, it is also possible to test whether the plurality of meshes can be aligned with the torso of the target object in the display interface.

In the technical solution of the embodiments of the present disclosure, upon detecting that the special effect mounting condition is satisfied, determining a target torso model corresponding to the target object, so as to determine a target special effect and target vertex information on the target torso model, determining a target mounting point corresponding to the target vertex information, and determining a current offset angle of the target object, finally mounting the target special effect on the target object based on the target mounting point and the current offset angle, to obtain a special effect video frame, thereby enabling the added special effect to be associated with the limbs of the user in the video image, meanwhile, the orientation of the special effect corresponds to the orientation of the limbs of the user in the image, making the visual effect presented by the special effect video more realistic, which improves the using experience of the user.

FIG. 2 is a structural diagram of an image processing apparatus provided by embodiments of the present disclosure. As shown in FIG. 2, the apparatus includes a target torso model determination module 210, a target vertex information determination module 220, a target mounting point determination module 230, and a special effect video frame generation module 240.

The target torso model determination module 210 is configured to determine a target torso model corresponding to a target object in the case where it is detected that a special effect mounting condition is satisfied.

The target vertex information determination module 220 is configured to determine a target special effect and target vertex information on the target torso model.

The target mounting point determination module 230 is configured to determine a target mounting point corresponding to the target vertex information, and determine a current offset angle of the target object.

The special effect video frame generation module 240 is configured to mount the target special effect on the target object based on the target mounting point and the current offset angle, to obtain a special effect video frame.

On the basis of the above embodiment, the image processing apparatus further includes a to-be-processed torso model determination module and a target torso model determination module.

The to-be-processed torso model determination module is configured to, determine a to-be-processed torso model corresponding to the target object in a case where it is detected that a display interface includes the target object; in which the to-be-processed torso model is constituted by at least one patch.

The target torso model determination module is configured to determine vertex information of the at least one patch, to obtain a target torso model corresponding to the target object, to determine target vertex information corresponding to a touch point on the target torso model in the case where the touch point is detected; in which the vertex information is different for each patch.

On the basis of the above embodiment, the target torso model determination module includes a to-be-processed map determination unit and a vertex information determination unit.

The to-be-processed map determination unit is configured to determine a to-be-processed map corresponding to the to-be-processed body torso model.

The vertex information determination unit is configured to determine vertex information of a plurality of patches based on the to-be-processed map.

On the basis of the above embodiment, the special effect mounting condition includes at least one of the following items: triggering a special effect mounting control; detecting that the target object is triggered; detecting that voice information triggers a special effect mounting wake-up word; and detecting that limb moving information is consistent with preset moving information.

Optionally, the target vertex information determination module 220 is configured to determine a touch point of the target object, determine target vertex information corresponding to the touch point on the target torso model based on the touch point; or, determine a mounting portion corresponding to voice information, and determine target vertex information of the target torso model corresponding to the mounting portion based on the mounting portion; or, determine the target vertex information according to a torso model corresponding to limb moving information.

On the basis of the above embodiment, the target vertex information determination module 220 includes a pixel determination unit and a target vertex information determination unit.

The pixel determination unit is configured to determine a pixel of the touch point in the display interface; or, determine a pixel corresponding to a center of the mounting portion; or, according to a torso model corresponding to the limb moving information, determine a geometric center point of the torso model, and taking the geometric center point as the pixel.

The target vertex information determination unit is configured to determine a target patch corresponding to the pixel, and determine the target vertex information corresponding to the touch point based on three vertex information of the target patch.

Optionally, the target vertex information determination unit is further configured to perform interpolation processing on the three vertex information based on the three vertex information of the target patch and the touch point, and determining the target vertex information of the touch point.

Optionally, the target mounting point determination module 230 is configured to determine a target mounting point on a display interface based on the target vertex information, and determine the current offset angle of the target object based on a deflection angle of the target torso model.

On the basis of the above embodiment, the target special effect is a relatively static special effect and a relatively dynamic special effect; the relatively static special effect is a special effect fixed at the target mounting point, and the relatively dynamic special effect is a moving special effect associated with the target mounting point.

On the basis of the above embodiment, the image processing apparatus further includes a display style determination module.

The display style determination module is configured to determine a display style, a moving rate, and a moving path of the relatively dynamic special effect.

Optionally, the special effect video frame generation module 240 is configured to take the target mounting point as a starting point of the relatively dynamic special effect, move according to the moving path and the moving rate to obtain the special effect video frame.

Optionally, the special effect video frame generation module 240 is configured to determine at least one path vertex of the target special effect on the target torso model based on the target vertex information of the target mounting point, the moving path, and the moving rate, and determine a special effect video frame of moving of the target special effect on the target torso model based on the target vertex information and the at least one path vertex.

In this embodiment, upon detecting that the special effect mounting condition is satisfied, determining a target torso model corresponding to the target object, so as to determine a target special effect and target vertex information on the target torso model, determining a target mounting point corresponding to the target vertex information, and determining a current offset angle of the target object, finally mounting the target special effect on the target object based on the target mounting point and the current offset angle, to obtain a special effect video frame, thereby enabling the added special effect to be associated with the limbs of the user in the video image, meanwhile, the orientation of the special effect corresponds to the orientation of the limbs of the user in the image, making the visual effect presented by the special effect video more realistic, which improves the using experience of the user.

The image processing apparatus provided by the embodiments of the present disclosure can perform the image processing method provided by any of the embodiments of the present disclosure, and includes the corresponding function modules for performing the method.

It is to be noted that the plurality of units and modules included in the above apparatus are divided only according to functional logic, but are not limited to the above division as long as the corresponding functions can be realized; in addition, the names of the plurality of functional units are merely for convenience of distinguishing from each other, and are not used to limit the protection scope of the embodiments of the present disclosure.

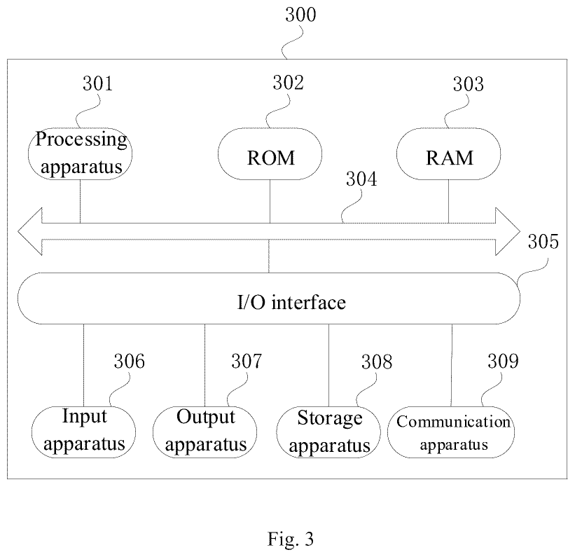

FIG. 3 is a structural diagram of an electronic device provided by embodiments of the present disclosure. FIG. 3 is referred below, and it shows the structural schematic diagram suitable for achieving the electronic device (the terminal device or server in FIG. 3) 300 in the embodiments of the present disclosure. The terminal device in the embodiments of the present disclosure may include but not be limited to a mobile terminal such as a mobile phone, a notebook computer, a digital broadcasting receiver, a personal digital assistant (PDA), a portable android device (PAD), a portable media player (PMP), a vehicle terminal (such as a vehicle navigation terminal), and a fixed terminal such as a digital television (TV) and a desktop computer. The electronic device shown in FIG. 3 is only an example and should not impose any limitations on the functions and use scopes of the embodiments of the present disclosure.

As shown in FIG. 3, the electronic device 300 may include a processing apparatus (such as a central processing unit, and a graphics processor) 301, it may execute various appropriate actions and processes according to a program stored in a read-only memory (ROM) 302 or a program loaded from a storage apparatus 308 to a random access memory (RAM) 303. In RAM 303, various programs and data required for operations of the electronic device 300 are also stored. The processing apparatus 301, ROM 302, and RAM 303 are connected to each other by a bus 304. An input/output (I/O) interface 305 is also connected to the bus 304.

Typically, the following apparatuses may be connected to the I/O interface 305: an input apparatus 306 such as a touch screen, a touchpad, a keyboard, a mouse, a camera, a microphone, an accelerometer, and a gyroscope; an output apparatus 307 such as a liquid crystal display (LCD), a loudspeaker, and a vibrator; a storage apparatus 308 such as a magnetic tape, and a hard disk drive; and a communication apparatus 309. The communication apparatus 309 may allow the electronic device 300 to wireless-communicate or wire-communicate with other devices so as to exchange data. Although FIG. 3 shows the electronic device 300 with various apparatuses, it should be understood that it is not required to implement or possess all the apparatuses shown. Alternatively, it may implement or possess the more or less apparatuses.

According to the embodiments of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 309, or installed from the storage apparatus 308, or installed from ROM 302. When the computer program is executed by the processing apparatus 301, the above functions defined in the method in the embodiments of the present disclosure are executed.

The names of messages or information interacted between devices in the implementations of the present disclosure are for illustrative purposes only and are not intended to limit the scope of such messages or information.

The electronic device provided by the embodiments of the present disclosure belongs to the same inventive concept as the image processing method provided by the above embodiments, technical details that are not elaborately described in the present embodiment can be referred to the above embodiments.

The embodiments of the present disclosure provide a computer storage medium, which stores a computer program, the computer program, when executed by a processor, implements the image processing method provided by the above embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: determine a target torso model corresponding to a target object in the case where it is detected that a special effect mounting condition is satisfied; determine a target special effect and target vertex information on the target torso model; determine a target mounting point corresponding to the target vertex information, and determining a current offset angle of the target object; and mount the target special effect on the target object based on the target mounting point and the current offset angle, to obtain a special effect video frame.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, [example one] provides an image processing method, the method includes: determining a target torso model corresponding to a target object in a case where it is detected that a special effect mounting condition is satisfied; determining a target special effect and target vertex information on the target torso model; determining a target mounting point corresponding to the target vertex information, and determining a current offset angle of the target object; and mounting the target special effect on the target object based on the target mounting point and the current offset angle, to obtain a special effect video frame.

According to one or more embodiments of the present disclosure, [example two] provides an image processing method, the method further includes: optionally, determining a to-be-processed torso model corresponding to the target object in the case where it is detected that a display interface includes the target object; in which the to-be-processed torso model is constituted by at least one patch; determining vertex information of the at least one patch, to obtain a target torso model corresponding to the target object, to determine target vertex information corresponding to a touch point on the target torso model in a case where the touch point is detected; in which the vertex information of each patch in the at least one patch is different.

According to one or more embodiments of the present disclosure, [example three] provides an image processing method, the method further includes: optionally, determining a to-be-processed map corresponding to the to-be-processed torso model; and determining the vertex information of the at least one patch based on the to-be-processed map.

According to one or more embodiments of the present disclosure, [example four] provides an image processing method, the method further includes that: optionally, the special effect mounting condition includes at least one of following items: triggering a special effect mounting control; detecting that the target object is triggered; detecting that voice information triggers a special effect mounting wake-up word; and detecting that limb moving information is consistent with preset moving information.

According to one or more embodiments of the present disclosure, [example five] provides an image processing method, the method further includes: optionally, determining a touch point of the target object, determining target vertex information on the target torso model corresponding to the touch point based on the touch point; or, determining a mounting portion corresponding to voice information, and determining target vertex information on the target torso model corresponding to the mounting portion based on the mounting portion; or determining the target vertex information according to a torso model corresponding to limb moving information.

According to one or more embodiments of the present disclosure, [example six] provides an image processing method, the method further includes: optionally, determining a pixel of the touch point on a display interface; or, determining a pixel corresponding to a center of the mounting portion; or, according to a torso model corresponding to the limb moving information, determining a geometric center point of the torso model, and taking the geometric center point as a pixel; determining a target patch corresponding to the pixel, and according to three vertex information of the target patch, determining target vertex information corresponding to the touch point.

According to one or more embodiments of the present disclosure, [example seven] provides an image processing method, the method further includes: optionally, performing interpolation processing on the three vertex information based on the three vertex information of the target patch and the touch point, and determining the target vertex information corresponding to the touch point.

According to one or more embodiments of the present disclosure, [example eight] provides an image processing method, the method further includes: optionally, determining a target mounting point on a display interface based on the target vertex information, and determining the current offset angle of the target object based on a deflection angle of the target torso model.

According to one or more embodiments of the present disclosure, [example nine] provides an image processing method, the method further includes that: optionally, the target special effect is a relatively static special effect and a relatively dynamic special effect; the relatively static special effect is a special effect fixed at the target mounting point, and the relatively dynamic special effect is a moving special effect associated with the target mounting point.

According to one or more embodiments of the present disclosure, [example ten] provides an image processing method, the method further includes: optionally, determining a display style, a moving rate, and a moving path of the relatively dynamic special effect.

According to one or more embodiments of the present disclosure, [example eleven] provides an image processing method, the method further includes: optionally, taking the target mounting point as a starting point of the relatively dynamic special effect, moving according to the moving path and the moving rate to obtain the special effect video frame.

According to one or more embodiments of the present disclosure, [example twelve] provides an image processing method, the method further includes: optionally, determining at least one path vertex of the target special effect on the target torso model based on the target vertex information of the target mounting point, the moving path, and the moving rate; and determining a special effect video frame of moving of the target special effect on the target torso model based on the target vertex information and the at least one path vertex.

According to one or more embodiments of the present disclosure, [example thirteen] provides an image processing apparatus, the apparatus includes: a target torso model determination module, configured to determine a target torso model corresponding to a target object in a case where it is detected that a special effect mounting condition is satisfied; a target vertex information determination module, configured to determining a target special effect and target vertex information on the target torso model; a target mounting point determination module, configured to determine a target mounting point corresponding to the target vertex information, and determining a current offset angle of the target object; and a special effect video frame generation module, configured to mount the target special effect on the target object based on the target mounting point and the current offset angle, to obtain a special effect video frame.

The foregoing are merely descriptions of the embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

1. An image processing method, comprising:
determining a target torso model corresponding to a target object in a case where it is detected that a special effect mounting condition is satisfied;
determining a target special effect and target vertex information on the target torso model;
determining a target mounting point corresponding to the target vertex information, and determining a current offset angle of the target object; and
mounting the target special effect on the target object based on the target mounting point and the current offset angle, to obtain a special effect video frame.

2. The method according to claim 1, before determining the target special effect and the target vertex information on the target torso model, further comprising:
determining a to-be-processed torso model corresponding to the target object in a case where it is detected that a display interface comprises the target object; wherein the to-be-processed torso model is constituted by at least one patch;
determining vertex information of the at least one patch, to obtain a target torso model corresponding to the target object, to determine target vertex information corresponding to a touch point on the target torso model in a case where the touch point is detected;
wherein the vertex information of each patch in the at least one patch is different.

3. The method according to claim 2, wherein determining the vertex information of the at least one patch, to obtain the target torso model corresponding to the target object comprises:
determining a to-be-processed map corresponding to the to-be-processed torso model; and
determining the vertex information of the at least one patch based on the to-be-processed map.

4. The method according to claim 1, wherein the special effect mounting condition comprises at least one of following items:
triggering a special effect mounting control;
detecting that the target object is triggered;
detecting that voice information triggers a special effect mounting wake-up word; and
detecting that limb moving information is consistent with preset moving information.

5. The method according to claim 1, wherein determining the target special effect and the target vertex information on the target torso model comprises:
determining a touch point of the target object, determining target vertex information corresponding to the touch point on the target torso model based on the touch point; or,
determining a mounting portion corresponding to voice information, and determining target vertex information on the target torso model corresponding to the mounting portion based on the mounting portion; or
determining the target vertex information according to a torso model corresponding to limb moving information.

6. The method according to claim 5, wherein determining the target special effect and the target vertex information on the target torso model comprises:
determining a pixel of the touch point on a display interface; or,
determining a pixel corresponding to a center of the mounting portion; or,
according to a torso model corresponding to the limb moving information, determining a geometric center point of the torso model, and taking the geometric center point as a pixel;
determining a target patch corresponding to the pixel, and according to three vertex information of the target patch, determining target vertex information corresponding to the touch point.

7. The method according to claim 6, wherein determining the target vertex information corresponding to the touch point according to the three vertex information of the target patch comprises:
performing interpolation processing on the three vertex information based on the three vertex information of the target patch and the touch point, and determining the target vertex information corresponding to the touch point.

8. The method according to claim 1, wherein determining the target mounting point corresponding to the target vertex information, and determining the current offset angle of the target object comprises:
determining a target mounting point on a display interface based on the target vertex information, and determining the current offset angle of the target object based on a deflection angle of the target torso model.

9. The method according to claim 1, wherein the target special effect is at least one of a relatively static special effect and a relatively dynamic special effect;
the relatively static special effect is a special effect fixed at the target mounting point, and the relatively dynamic special effect is a moving special effect associated with the target mounting point.

10. The method according to claim 1, further comprising:
determining a display style, a moving rate, and a moving path of the relatively dynamic special effect.

11. The method according to claim 10, wherein mounting the target special effect on the target object, to obtain the special effect video frame comprises:
taking the target mounting point as a starting point of the relatively dynamic special effect, moving according to the moving path and the moving rate to obtain the special effect video frame.

12. The method according to claim 11, wherein taking the target mounting point as the starting point of the relatively dynamic special effect, moving according to the moving path and the moving rate to obtain the special effect video frame comprises:
determining at least one path vertex of the target special effect on the target torso model based on the target vertex information of the target mounting point, the moving path, and the moving rate; and
determining a special effect video frame of moving of the target special effect on the target torso model based on the target vertex information and the at least one path vertex.

13. (canceled)

14. An electronic device, comprising:
at least one processor; and
a storage apparatus, configured to store at least one program,
the at least one program, when executed by the at least one processor, causes the at least one processor to:
determine a target torso model corresponding to a target object in a case where it is detected that a special effect mounting condition is satisfied;
determine a target special effect and target vertex information on the target torso model;
determine a target mounting point corresponding to the target vertex information, and determining a current offset angle of the target object; and
mount the target special effect on the target object based on the target mounting point and the current offset angle, to obtain a special effect video frame.

15. A storage medium, comprising computer-executable instructions, wherein the computer-executable instructions, when executed by a computer processor, are used for performing an image processing method, the method comprises:
determining a target torso model corresponding to a target object in a case where it is detected that a special effect mounting condition is satisfied;
determining a target special effect and target vertex information on the target torso model;
determining a target mounting point corresponding to the target vertex information, and determining a current offset angle of the target object; and
mounting the target special effect on the target object based on the target mounting point and the current offset angle, to obtain a special effect video frame.
